(19) United States
(12) Patent Application Publication
(10) Pub. No.: US 2026/0155998 A1
(43) Pub. Date: Jun. 4, 2026

(54) IDENTIFICATION INFORMATION MANAGEMENT METHOD, SERVER, AND COMPUTER PROGRAM PRODUCT

(71) Applicant: DENSO CORPORATION, Kariya-city (JP)

(72) Inventor: Xin XU, Kariya-city (JP)

(21) Appl. No.: 19/423,586

(22) Filed: Dec. 17, 2025

Related U.S. Application Data
(63) Continuation of application No. PCT/JP2024/022921, filed on Jun. 25, 2024.

(30) Foreign Application Priority Data
Jun. 30, 2023 (JP) 2023-107836

(51) Int. Cl. H04L 9/32; H04L 9/00

(52) U.S. Cl. CPC H04L 9/3249; H04L 9/3239; H04L 9/50

(57) ABSTRACT

An issuance server issues an identifier, a private key associated with the identifier, and a public key corresponding to the private key, based on a request from a user device. The issuance server communicates with the user device to identify the type of the user device. The issuance server then stores the private key in a secure area corresponding to the type of the user device, and registers the identifier and the public key in a blockchain-based registry.

### CROSS REFERENCE TO RELATED APPLICATIONS

The present application is a continuation application of International Patent Application No. PCT/JP 2024/022921 filed on Jun. 25, 2024, which designated the U.S. and claims the benefit of priority from Japanese Patent Application No. 2023-107836 filed on Jun. 30, 2023. The entire disclosures of all of the above applications are incorporated herein by reference.

### TECHNICAL FIELD

The present disclosure relates to a technique for verifying a validity of received data.

### BACKGROUND

One method for managing digital identities is DIDs (Decentralized Identifiers), proposed by the World Wide Web Consortium. DIDs is a technology/mechanism that uses a distributed ledger system such as blockchain to distribute and manage digital identities.

### SUMMARY

According to an aspect of the present disclosure, an identification information management method may include: issuing, based on a request from a device, an identifier, a private key associated with the identifier, and a public key corresponding to the private key; acquiring data indicating a device type from the device to identify the device type; specifying a secure area in which to store the private key based on the device type; storing the private key in the secure area; and registering the identifier and the public key in a blockchain-based registry.

### BRIEF DESCRIPTION OF DRAWINGS

FIG. 1 is a diagram showing an overall configuration of an ID management system.

FIG. 2 is a diagram showing a configuration of a user device.

FIG. 3 is a diagram showing a configuration of an issuance server.

FIG. 4 is a functional block diagram of an issuance server.

FIG. 5 is a functional block diagram of a service server.

FIG. 6 is a flowchart showing a procedure for issuing and registering a key pair and a DID.

FIG. 7 is a diagram for explaining a configuration of a DID.

FIG. 8 is a diagram showing an example of a DID document.

FIG. 9 is a diagram showing another example of a DID document.

FIG. 10 is a flowchart showing a message validation process.

FIG. 11 is a diagram for explaining an example of a method for providing service using a DID.

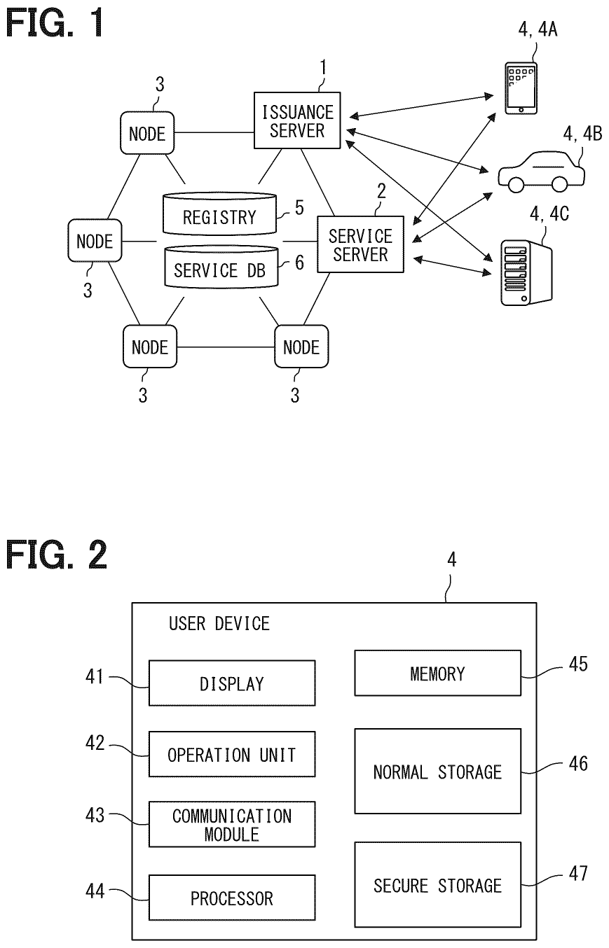

### DETAILED DESCRIPTION

One method for managing digital identities is DIDs (Decentralized Identifiers), proposed by the World Wide Web Consortium. DIDs is a technology/mechanism that uses a distributed ledger system such as blockchain to distribute and manage digital identities. A method authenticates a user attempting to log in to a platform using the DIDs mechanism. Digital signatures generated with a private key are used for user authentication and data verification.

In the current DIDs, there are no regulations regarding the storage location of the private key in the user device, and there is no mechanism for restricting the storage location of the private key. Additionally, depending on the type of user device, the medium on which the private key is stored may have different levels of security. The type may be interpreted as specification, function, or setting.

For this reason, depending on the type of user device, the private key may be stored in a storage area with a low level of security. A low security level increases the risk of the private key being leaked. If the private key is leaked from the user device, DIDs-based services may be compromised.

The present disclosure provides an identification information management method, server, and program product, to reduce the risk of unauthorized use of a service.

The identification information management method disclosed herein includes: issuing, based on a request from a device, an identifier, a private key associated with the identifier, and a public key corresponding to the private key; acquiring data indicating a device type from the device to identify the device type; specifying a secure area in which to store the private key based on the device type; storing the private key in the secure area; and registering the identifier and the public key in a blockchain-based registry.

According to the above method, the storage location of the private key is set to an area that is predefined as a secure area according to the device type. This reduces the risk of the private key being leaked and used illegally. As a result, the risk of unauthorized use of the service can be reduced.

A server included in the present disclosure to manage identification information is configured to, based on a request from a device used by a user: issue an identifier, a private key associated with the identifier, and a public key corresponding to the private key; acquire data indicating the type of the device from the device to identify the type of the device; specify a secure area in which to store the private key based on the identified device type; send an instruction signal to the device to store the private key in the secure area; and register the identifier and the public key in a blockchain-based registry.

A program included in the present disclosure includes instructions to cause a computer provided in a device used by a user to: receive a request for issuance of an identifier via an input device; send a request signal to a server to request issuance of an identifier based on the reception of the request for issuance of the identifier; send data indicating the type of the device to the server; receive a private key associated with the identifier from the server; and store the private key in a memory area specified by the server.

Hereinafter, an embodiment of the present disclosure will be described with reference to the drawings. The present disclosure is not limited to the following embodiment. The configurations disclosed below may be modified and implemented in various ways without departing from the spirit. The various modified examples may be combined as appropriate within the scope of the present disclosure so long as no technical contradiction arises. The present disclosure also includes configurations that are not explicitly stated and are formed by combining multiple modified examples. In the following description, components having the same functions are denoted by the same reference numerals, and specific descriptions thereof may be omitted. When only a part of a configuration is mentioned, descriptions given elsewhere may apply to other parts.

### System Configuration

The ID management system 100 disclosed herein reduces the risk of unauthorized use of identification information (i.e., ID: Identifier) used to authenticate an entity (in other words, a user) while absorbing differences in specifications for user devices 4. The ID management system 100 may include an issuance server 1, a service server 2, plural nodes 3, and plural types of user devices 4.

The issuance server 1 is configured to issues IDs of users. The service server 2 is configured to provide a service to a user through communication with the user device 4. The service may include distribution of coupons, diagnosis of the user device 4, exchange of virtual currency, administrative procedures, dispatching a taxi, and the like. The node 3 is a computer that performs mining in a blockchain. The issuance server 1, the service server 2, and the node 3 participate in a blockchain network. The issuance server 1 and the service server 2 may also be considered as one of the nodes 3 belonging to the blockchain network. The node 3 is an optional element. When the blockchain, to which the issuance server 1 accesses, is a private blockchain, the node 3 may be omitted. Hereinafter, the issuance server 1, the service server 2, and the node 3 will be collectively referred to as the issuance server 1, etc.

The issuance server 1 etc. is equipped with a storage device for storing blockchain data. The issuance server 1 etc. is configured to share blockchain data. The issuance server 1 etc. has a registry 5 and a service DB 6 as storage area realized using a blockchain. DB is an abbreviation for database. The registry 5 is a storage area that records the ID of each entity (for example, a user). In this embodiment, the ID is a decentralized identifier (DID), as described below. The registry 5 corresponds to a Verifiable Data Registry (VDR).

The service DB 6 is a recording area for recording service data. The service data in this disclosure is data necessary for providing a service. For example, in a service that distributes coupons according to user location information, data indicating the user's location may be considered service data. The service DB 6 may store a smart contract that automatically executes processing according to the registered message. The registry 5 and the service DB 6 may be logical storage.

The blockchain that functions as the registry 5 and the service DB 6 may be a consortium-type blockchain. In another embodiment, the blockchain may be a public/private blockchain. The blockchain may be implemented using Hyperledger® Fabric.

In this embodiment, the registry 5 and the service DB 6 are realized on one blockchain, but the method of realizing the registry 5 and the service DB 6 is not limited to this. The blockchain for the registry 5 and the blockchain for the service DB 6 may be separate. The combination of the nodes 3 forming a blockchain including the registry 5 may be different from the combination of the nodes 3 forming a blockchain including the service DB 6. The ID management blockchain that functions as the registry 5 and the service blockchain that functions as the service DB 6 may have different formats and constituent members. The ID management blockchain is of the consortium type, while the service blockchain may be of the public or private type.

When there are multiple services, there may be an independent blockchain for each service. The combination of the nodes 3 that form the blockchain may differ for each service. Furthermore, the registry 5 does not necessarily have to be formed on a blockchain. In other words, the place where the DID is stored does not have to be the blockchain. The location where the DID is stored may be a specific database.

### User Device Configuration

The user device 4 will be described. The user device 4 may be a smartphone 4A, a vehicle 4B, a server 4C, or the like. The vehicle 4B may be understood as an Electronic Control Unit (ECU) or computer installed in a vehicle. The server 4C may be an on-premise server or a cloud server. Alternatively, the user device 4 may be a laptop, desktop PC, tablet, etc.

The user devices 4 may include devices of different types. The type here may be rephrased as specification, function, or setting. For example, the multiple user devices 4 may have different operating systems (OS). Furthermore, the multiple user devices 4 may have different local storage mechanisms.

Each of the user devices 4 is configured to communicate with the issuance server 1 and the service server 2 via the Internet. The user device 4 can transmit and receive data to and from the issuance server 1 based on a user's operation or automatically according to a program. Each of the user devices 4 has client software 40 installed therein, which performs processes related to issuing a DID on the user device 4 side. The client software 40 performs data communication with the issuance server 1. The client software 40 may be paired with a server program installed in the issuance server 1.

As shown in FIG. 2, the user device 4 includes a display 41, an operation unit 42, a communication module 43, a processor 44, a memory 45, a normal storage 46, and a secure storage 47.

The display 41 is a device that displays an image according to an input signal from the processor 44. The operation unit 42 is a device for receiving instructions from a user to the user device 4. The operation unit 42 may be a hardware switch or a touch panel stacked on the display 41. The operation unit 42 outputs a signal corresponding to a user operation to the processor 44. The communication module 43 is a circuit module for connecting to the Internet and communicating with the issuance server 1. The communication module 43 may be a wireless communication module for cellular communication such as 4G or 5G.

The processor 44 is configured to execute various types of arithmetic processing. The processor 44 may be a central processing unit (CPU) or a graphics processing unit (GPU), for example. The memory 45 may be a RAM (Random Access Memory).

The normal storage 46 and the secure storage 47 are realized using rewritable non-volatile storage media. The normal storage 46 is a storage area that can be accessed by various applications. The normal storage 46 may be an area where data is stored without being encrypted. The normal storage 46 corresponds to a normal area. The resources of the user device 4 may be divided into a normal world and a secure world using technology such as Trusted Execution Environment (TEE). When the resources of the user device 4 are divided into a normal world and a secure world, the normal storage 46 may be understood in one respect as storage in the normal world.

The secure storage 47 is an area separated from the normal storage 46 and has a certain level of confidentiality and integrity. The secure storage 47 may be a storage area that is physically separated from the normal storage 46. The secure storage 47 may be a storage area that can only be accessed by specific kernels/applications. In another embodiment, the secure storage 47 may be a storage area that is virtually separated from the normal storage 46. In one respect, the secure storage 47 may be understood as storage in a secure world that is isolated from the normal world.

The secure storage 47 may be an area to which a specific data storage method is applied. It is preferable that the specific data storage method has been confirmed by the designer of the issuance server 1 or a third party organization to have the desired confidentiality. The secure storage 47 may be a storage that incorporates a mechanism for automatically encrypting and storing data.

The actual storage area corresponding to the secure storage 47 may vary depending on the type of the user device 4. For an Android® smartphone, the secure storage 47 may be a storage area protected by a TEE or a Secure Element provided by the Android KeyStore. The TEE may be an environment implemented by Intel® SGX or Arm TrustZone®. For the user device 4 that runs on iOS® such as an iPhone®, the secure storage 47 may be a storage area protected by the Secure Enclave. For the user device 4 running Linux®, the secure storage 47 may be a storage area protected by the Secure Enclave. The secure storage 47 may be a cloud storage protected by AWS® CloudHSM, Azure® Key Vault, or the like. Alternatively, the secure storage 47 may be a trusted storage.

In addition, the secure storage 47 may also include a USB memory type hardware wallet. The secure storage 47 may be configured to be removable from the user device 4. The secure storage 47 corresponds to a secure area. The storage area that the issuance server 1 regards as the secure area (secure storage 47) may be defined in advance in the issuance server 1. The issuance server 1 may have data (for example, a list/table) in which secure areas of each type are defined.

The normal storage 46 or the secure storage 47 stores device-oriented programs executed by the processor 44. The device-oriented program includes the client software 40. The processor 11 may execute the client software 40 to function as the user device 4 in the following description. For example, the user device 4 accepts a user operation for issuing a DID via the operation unit 42. In addition, in response to the user operation, the user device 4 transmits a signal to the issuance server 1 requesting the issuance of a DID.

### Issuance Server Configuration

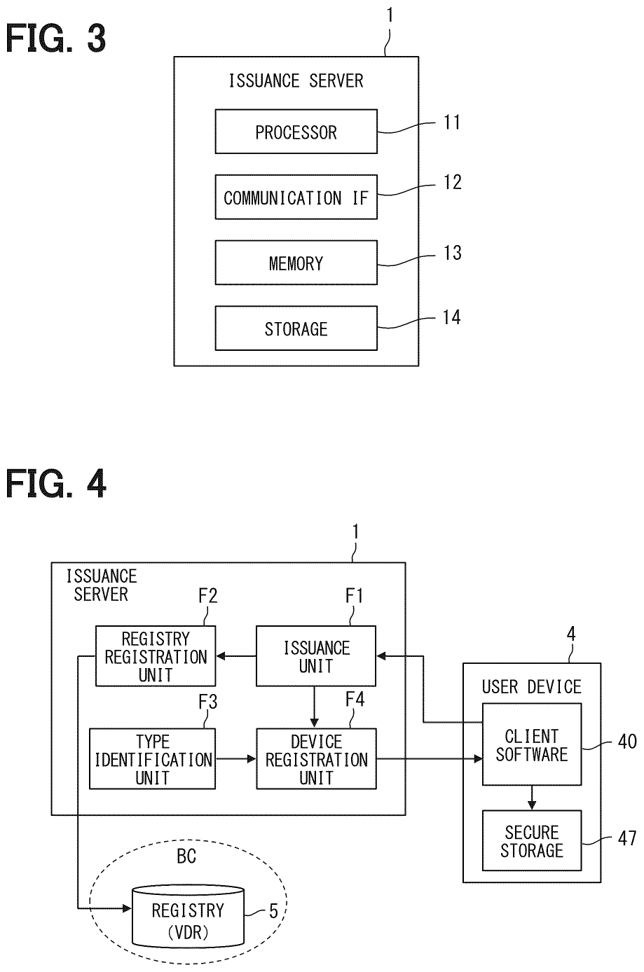

The issuance server 1 performs processes related to issuing a DID and generating a key pair associated with the DID. The key pair includes a private key and a public key. The details of DID will be described later. As shown in FIG. 3, the issuance server 1 includes a processor 11, a communication interface 12, a memory 13, and a storage 14.

The processor 11 is configured to perform arithmetic processing based on data received from other devices. The processor 11 may be a CPU or a GPU, for example. The communication interface 12 is a circuit module that enables the processor 11 to communicate with other devices. The communication interface 12 may include circuitry for connecting to the Internet.

The memory 13 is a rewritable volatile storage medium. The memory 13 may be a RAM. The memory 13 may be a component for temporarily storing data received from other devices, calculation results of the processor 11, programs, etc. The storage 14 is a rewritable non-volatile memory. The storage 14 is realized by at least one type of non-transitory tangible storage medium, such as a semiconductor memory, a magnetic medium, or an optical medium. The storage 14 may include multiple types of storage media, such as a ROM (Read Only Memory) and a flash memory. The storage 14 stores a server program, which is a program executed by the processor 11. The server program may be a program for realizing at least a part of the functions of the issuance server 1 shown as a block in FIG. 4.

The server program and the client software 40 may be developed and implemented using SDK (Software Development Kit) that is applicable to various types of the user devices 4. The execution of the server program and the client software 40 corresponds to an execution of an identification information management method.

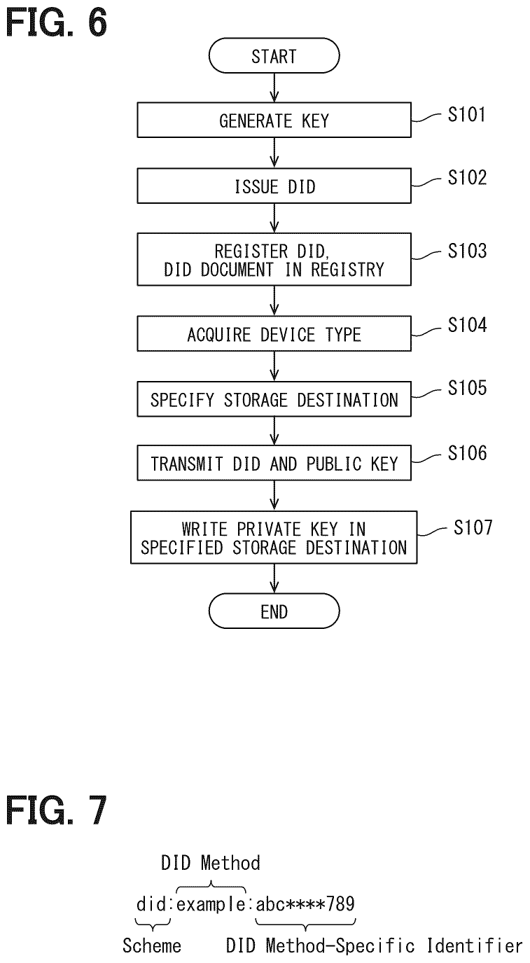

As shown in FIG. 4, the issuance server 1 includes, as functional blocks, an issuance unit F1, a registry registration unit F2, a type identification unit F3, and a device registration unit F4. Each functional block may be realized by the processor 11 executing a server program. The issuance unit F1, the registry registration unit F2, the type identification unit F3, and the device registration unit F4 are functional blocks related to the registration of the key pair and the DID. The operation of each functional block will be described later with reference to FIG. 6.

### Service Server Configuration

Like the issuance server 1, the service server 2 is a computer that includes a processor, a communication interface, a memory, and a storage. The storage stores a program to be executed by the processor for providing the service.

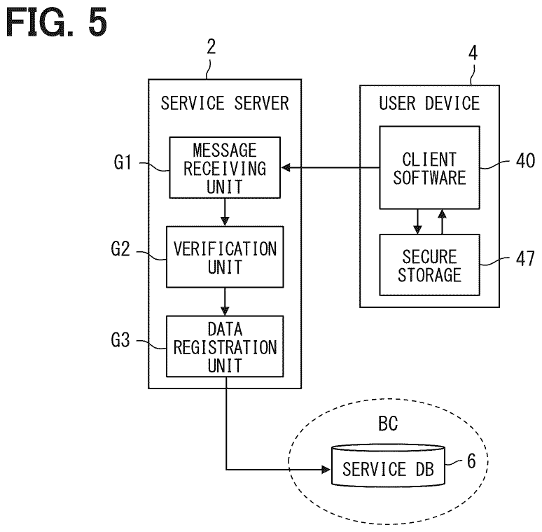

As shown in FIG. 5, the service server 2 includes, as functional blocks, a message receiving unit G1, a verification unit G2, and a data registration unit G3. Each functional block may be realized by a processor executing a predetermined program. The message receiving unit G1, the verification unit G2, and the data registration unit G3 are functional blocks for adding a message sent from the user device 4 using the issued DID to the blockchain. The message may be referred to as a request, a transaction, or service data. The operation of each functional block will be described later with reference to FIG. 9.

### Issuance of Key Pair and DID

The operation of the issuance server 1 for issuing a key pair and a DID will be described with reference to FIG. 6. The flowchart shown in FIG. 6 may be started when the issuance server 1 receives a DID issuance request from the user device 4. Hereinafter, references to the client software 40 may be replaced with the user device 4 or the processor 44. In addition, the descriptions of the issuance unit F1, the registry registration unit F2, the type identification unit F3, and the device registration unit F4 below may be replaced with the issuance server 1 or the processor 11. Hereinafter, the user device 4 that has sent the request to issue a DID or the owner of the user device 4 will also be referred to as request source.

In step S101, the issuance unit F1 generates a key pair of a public key and a private key for the request source. The generation of the key pair may be performed in any manner, such as RSA. When step S101 is completed, the process proceeds to step S102.

In step S102, the issuance unit F1 generates a code to be used as a DID based on the public key generated in step S101. The DID is an identifier having a format defined by the World Wide Web Consortium (W3C). As shown in FIG. 7, the DID includes a scheme, a DID method, and a method-specific identifier. Each element is separated by a colon. The scheme is a prefix that indicates what follows is a DID method, etc. The DID method is a code that specifies the type of mechanism by which the DID is operated, in other words, the method of interpreting the identifier. The information of the DID method can be used by the service server 2 to specify a method for acquiring a document indicating information linked to a DID (a so-called DID document). The DID method may be any method. The method-specific identifier is assigned a value that is unique within the method. The combination of the method specific identifier and the DID method uniquely defines an entity (DID subject). The method of generating the method-specific identifier may vary from DID method to DID method. The method for generating the method-specific identifier may be any method. The issuance unit F1 may be configured to issue a DID using any DID method. When step S102 is completed, the process proceeds to step S103.

The generation of the key pair and the issuance of the DID may be performed by separate devices. The functions of the issuance unit F1 may be divided into multiple parts. Further, some or all of the functions of the issuance unit F1 may be provided in another server. Furthermore, some or all of the functions of the issuance unit F1 may be provided by the client software 40. When the key generation function is provided outside the issuance server 1, step S101 may be a step of obtaining a key pair. When the DID issuing function is provided outside the issuance server 1, step S102 may be a step of acquiring the issued DID.

The issuance unit F1 may include an API (Application Programming Interface) for accepting DID issuing requests from various types of the user devices 4. The issuance unit F1 may include plural reception APIs corresponding to the device types, respectively. This enables the issuance unit F1 to absorb differences in the types of request sources.

In step S103, the registry registration unit F2 performs preparation process required for registering the DID and stores the DID and the DID document in the registry 5. The preparation process may include generating data in JSON format that represents the DID Document. The preparation process may also include sending the DID document to the client software 40 for user confirmation, and signing the DID document with the private key generated in step S101.

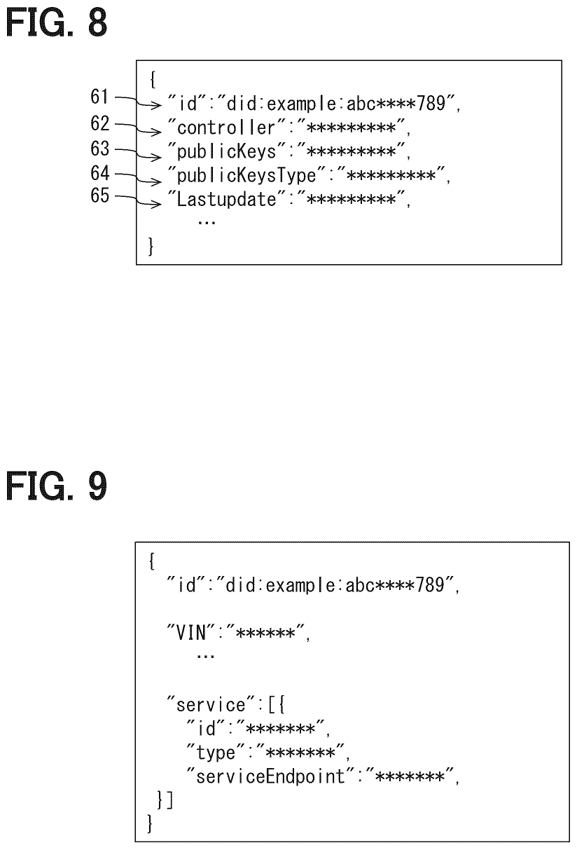

As shown in FIG. 8, the DID document may include, for example, a DID subject 61, a DID controller 62, a public key 63, a public key type 64, and a last update date 65. The DID subject 61 indicates the owner (i.e., user) of the DID. The DID subject 61 stores the DID itself. The DID controller 62 represents an entity authorized to make changes to the DID document. The DID controller 62 may represent the DIDs of the entities that have modification authority. The public key 63 is the public key generated in step S101. The public key type 64 indicates the type of the public key.

The DID document shown in FIG. 8 is an example. The DID document may contain data on the type, owner, and services available to the user. The data on available services may be described separately from the main body using a specific property such as “Service”. In addition, the DID document for use of a service may be created separately for each service. FIG. 9 is an example of a document for a service. Multiple DID documents may be created for one DID. The DID document can be created for each purpose/use and stored in a distributed manner. The items contained in the DID document may be described in separated manner by properties according to purpose/content.

The DID document can be stored in the registry 5 in an encrypted format so as to be restored by a predetermined function called a resolver. The resolver may differ depending on the DID method. In this disclosure, obtaining information contained in a DID document associated with a DID using a resolver is also referred to as DID resolving. Obtaining a public key associated with a DID may also be included as one form of DID resolving.

When step S103 is completed, the process proceeds to step S104. In step S104, the type identification unit F3 acquires device type data from the client software 40. The device type data indicates the type of the user device 4. The device type data may be data indicating the OS or model of the user device 4. The device type data may be data indicating the type, specifications, or location of the secure storage 47 held by the user device 4. The device type data may be data that indicates a combination of storages that the user device 4 can access. The type identification unit F3 may obtain the device type data by requesting the client software 40 to transmit the device type. In another embodiment, the device type data may be included in the request for issuance of a DID. When step S104 is completed, the process proceeds to step S105.

In step S105, the device registration unit F4 determines a storage destination of the private key according to the type of the user device 4. The destination for storing the private key is selected from among the various secure storages 47. For example, when the user device 4, which is a request source, is an Android-based smartphone, the device registration unit F4 designates an area used by the TEE as the storage destination of the private key. When the user device 4 that has made the request is a device that runs on iOS, the device registration unit F4 designates an area protected by the Secure Enclave as the storage destination for the private key. When the user device 4 that has made the request does not have a secure storage 47, the device registration unit F4 may specify a specific external storage as the storage destination. The specified external storage may be a secure storage 47 on the cloud or a hardware wallet. The device registration unit F4 may specify multiple types of secure areas as the storage destinations for the private key. When step S105 is completed, the process proceeds to step S106.

In step S106, the device registration unit F4 transmits to the client software 40 a data set including the private key storage destination, the private key, and the DID. This information may be sent in multiple messages. When the client software 40 has a function related to key generation and DID issuance, the data sent by the device registration unit F4 may be a message specifying the storage destination of the private key. The transmission of data that has already been acquired by the client software 40 may be omitted. In response to step S106, the client software 40 executes step S107.

In step S107, the client software 40 stores the private key in the secure storage 47 based on an instruction from the device registration unit F4. The process of storing the private key in the secure storage 47 may be performed in cooperation with the software/hardware that forms the secure storage 47. The DID and the public key may be stored in the normal storage 46 or in the secure storage 47. The client software 40 may also obtain information other than the public key contained in the DID document from the issuance server 1 and store it in any storage device. The client software 40 may be configured to store the DID document in the normal storage 46 or in the secure storage 47.

When the user device 4 does not have a storage location for the private key specified by the issuance server 1, the client software 40 may display a message on the display 41 prompting the user to obtain the specified secure storage 47. When a hardware wallet is specified as the storage destination for the private key and the hardware wallet is not connected, the client software 40 may display a guide image requesting the user to connect the hardware wallet to the user device 4.

In this way, the issuance server 1 controls the operation of the user device 4 such that, in the user device 4, the private key is stored in an area having a certain level of security. This reduces the risk of the private key being leaked.

### Service Data/Message Registration Process

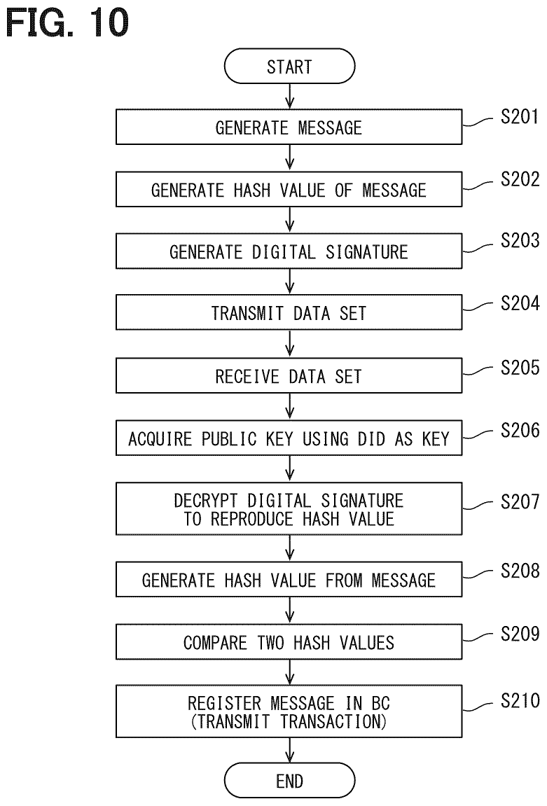

The operation of the user device 4 and the service server 2 relating to message transmission and reception will be described with reference to the flowchart shown in FIG. 10. The flowchart shown in FIG. 10 may be started in response to the occurrence of a trigger in the user device 4 to send a message (in other words, data) to the service server 2. The transmission trigger may be designed appropriately. The user device 4 may be programmed to send messages periodically. The message sending conditions may be appropriately designed depending on the content of the service. The following descriptions of the message receiving unit G1, the verification unit G2, and the data registration unit G3 may be replaced with the service server 2 or its processor.

First, the user device 4 generates a message in step S201. The message contains data about the item to be registered in the service DB 6. In other words, the message has a payload according to the service provided by the service server 2. The message may be generated by a predetermined application, not by the client software 40. The generation of the message may be performed by the client software 40. The following processing of the user device 4 may also be performed by the client software 40 or by another application. When step S201 is completed, the process proceeds to step S202.

In step S202, the user device 4 generates a hash value by converting the message generated in step S201 using a predetermined hash function. The hash value is data used to create a digital signature. The hash value generated in step S202 may be rephrased as a digest value of the message.

The hash function used to create the digital signature may be SHA-256. The hash function may be SHA-1, SHA512, MD-5, RIPEMD-160, etc. SHA stands for Secure Hash Algorithm. MD stands for Message Digest algorithm. RIPEMD stands for Race Integrity Primitive Evaluation Integrity Primitives Evaluation Message Digest. When step S202 is completed, the process proceeds to step S203.

In step S203, the user device 4 encrypts the hash value generated in step S202 using a private key. The encryption method may be RSA or the like. The encrypted hash value represents the digital signature of the message.

In step S204, the user device 4 transmits to the service server 2 a data set including the message generated in step S201, the digital signature generated in step S203, and the DID. When step S204 is completed, the process proceeds to step S205. In this disclosure, a data set in which a digital signature and a DID are added to a message body is referred to as a message set.

In step S205, the message receiving unit G1 receives the message set transmitted from the user device 4. The message receiving unit G1 may include an API for receiving message sets sent from various types of user devices 4. When the message receiving unit G1 receives the message set, the process proceeds to step S206.

In step S206, the verification unit G2 acquires a public key from the registry 5 using the DID included in the received message set as a key. The public key associated with a DID may be obtained by the DID resolving. When step S206 is completed, the process proceeds to step S207.

In step S207, the verification unit G2 decrypts the digital signature included in the message set with the public key acquired in step S206, and restores the hash value of the message. When step S207 is completed, the process proceeds to step S208. The order of the processes may be changed as appropriate.

In step S208, the verification unit G2 generates a hash value by converting the message body included in the message set using a common hash function. The common hash function is used by the user device 4 to create the electronic signature. The hash value generated in step S208 is an element to be checked against the hash function generated in step S207. In this disclosure, the hash value generated in step S208 is also referred to as a matching hash value. When step S208 is completed, the process proceeds to step S209.

In step S209, the verification unit G2 compares the hash value generated in step S207 with the hash value generated in step S208 to determine the authenticity of the message. When the two hash values match, the verification unit G2 determines that the message is valid. When the two hash values do not match, the verification unit G2 determines that the message is fraudulent. When the verification unit G2 determines that the message is fraudulent, in other words, when the two hash values do not match, the received message is discarded. When the two hash values do not match, the verification unit G2 may return an error message to the sender. On the other hand, when the verification unit G2 determines that the message is valid, in other words, when the two hash values match, the received message is transmitted to the data registration unit G3.

When the data registration unit G3 receives a message from the verification unit G2, the data registration unit G3 executes processing to register the message in the blockchain (step S210). For example, the data registration unit G3 temporarily stores the message in a transaction pool. When a predetermined number of messages have accumulated in the transaction pool, the data registration unit G3 generates a block and adds it to the blockchain. The consensus algorithm for adding a block may be any algorithm, such as Proof of Work (PoW) or Proof of Consensus (PoC).

The user device 4 may send a message set not only to the service server 2 but also to all other nodes that form the blockchain. The nodes 3 may execute the processes of steps S205 to S210. The data registration unit G3 may be configured to transmit the message, the validity of which has been confirmed, to all other nodes forming the service DB 6.

According to the above configuration, it is possible to record data related to the provision of services while ensuring authenticity by using the blockchain mechanism. The private key used to verify the authenticity of the data is controlled by the issuance server 1 so as to be stored in the secure storage 47. This reduces the risk of unauthorized use of the service due to leakage of the private key, etc. Since data verification or user authentication is performed on a DID basis, the servicer does not need to take into account the type of the user device 4. By incorporating a mechanism for controlling the storage location of the private key in the user device 4 in a system that performs authentication using the DID, it becomes possible to standardize the authentication method for a variety of the user devices 4 while ensuring security.

### Modification of Functional Arrangement

The service server 2 may be integrated with the issuance server 1. That is, the issuance server 1 may include the message receiving unit G1, the verification unit G2, and the data registration unit G3 related to a certain service. The functional layout of the ID management system 100 may be changed as appropriate. The ID management system 100 may include multiple service servers 2. One or more smart contracts may be registered in the service DB 6. The smart contract is a program that automatically executes a specified process corresponding to a service when a registered message (in other words, a transaction) satisfies certain conditions.

The ID management system 100 may also include Encrypted Data Vaults (EDVs) that store auxiliary data associated with the execution of a service. The EDV may be constructed in the registry 5 or in the service DB 6. The ancillary data associated with the execution of the service may be information about the holder linked to the DID, a list of available services, and the like. The ancillary data for vehicle specific services may include Vehicle Identification Number (VIN) and owner information.

The ID management system 100 may include a relay server that performs tasks such as creating an electronic signature. The relay server relays communication between the service server 2 and a device on which the client software 40 cannot be installed. For convenience, this disclosure refers to devices that do not have the client software 40 installed as non-compliant devices. The relay server itself holds the DID and the private key associated with it. The relay server authenticates the non-compliant device and its user using information other than the DID, such as a password, a one-time passcode, or biometric information. The relay server may generate a message set by attaching a digital signature using its own private key and its own DID to the message received from the authenticated non-compliant device, and transmit the message set to the service server 2. The relay server may have a function of transferring data generated from the service server 2 or the smart contract to a non-compliant device.

### Example Of Service

The advantages of utilizing the DID will be described by taking as an example a case where the ID management system 100 includes an LBS server 2a, which is a service server 2 that provides an LBS (Location Based Service). LBS is a service that uses the location information of the user device 4. For example, the LBS server 2a may obtain location information of the user device 4. For convenience, in this disclosure, a service that distributes a coupon to the user device 4 (or a user) based on the user device 4 entering a specific area is referred to as a coupon distribution service. The entry of the user device 4 into a specific area may be detected by the location information of the user device 4 satisfying a specific condition.

In the following description, it is assumed that the owner of the user device 4 (i.e., the user) is a person who has the authority to use the coupon distribution service. That is, data indicating that the coupon distribution service is available is registered in the user's DID document. The ID management system 100 includes an LBS-BC 6a, which is a blockchain for the LBS. The LBS server 2a is a node participating in the network of the LBS-BC 6a. The LBS-BC 6a is equipped with a smart contract SCa adapted for the coupon distribution service.

The smart contract SCa may be a program that issues a coupon to a user associated with a message (transaction) whose location information satisfies certain conditions based on the registration of the message. The user device 4 may be a vehicle 4B, a smartphone 4A, or the like. The LBS-BC 6a corresponds to the service DB 6.

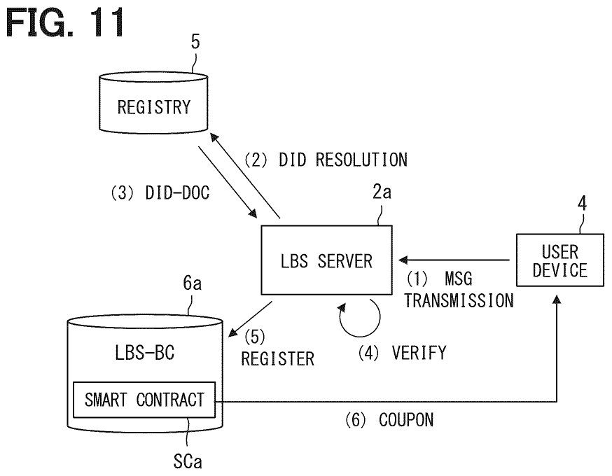

In the situation illustrated in FIG. 11, while the user device 4 is moving, it generates a message set at a predetermined reporting interval and transmits it to the LBS server 2a ((1) in FIG. 11). The message set generated here is a data set that includes data for LBS as a message body. The message body may be location information of the user device 4. The message set may be a data set including location information of the user device 4, an identification number as a DID (i.e. a distributed identifier), and an electronic signature. The message set need not contain any personal information other than the distributed identifier. The location information may be the result of calculations by a Global Navigation Satellite System (GNSS) receiver. The GNSS may be GPS, Galileo, IRNSS, QZSS, or BeiDou. The reporting interval may be 10 seconds, 1 minute, 10 minutes, etc.

When the LBS server 2a receives the message set, it performs processing for resolving the DID ((2) in FIG. 11). As a result, the LBS server 2a obtains the public key linked to the DID of the message set from the registry 5 ((3) in FIG. 11). When the LBS server 2a acquires the public key, it uses the public key to verify the authenticity of the received message ((4) in FIG. 11). The verification flow may be similar to steps S207 to S209.

When the LBS server 2a determines as a result of the above verification that the received message is valid, it registers the message in the LBS-BC 61a ((5) in FIG. 11). When the location information included in the registered message satisfies certain conditions, the smart contract SCa issues a coupon to the user ((6) in FIG. 11). When the location information included in the registered message does not satisfy certain conditions, the smart contract SCa will not issue a coupon to the user.

The function of verifying whether the sender of the location information (in other words, the user) has the right to use the coupon distribution service may be provided by the LBS server 2a or the smart contract SCa. Whether the sender of the location information has the right to use the service may also be determined based on the DID resolving/DID document. The LBS server 2a may be a server having only the function of receiving a message set from the user device 4 and verifying the validity of the message in the DID resolving. Processing related to coupon distribution, etc. may be executed by the smart contract SCa.

The coupon distribution may be carried out on the LBS-BC 61a (i.e., the blockchain). The coupon distribution may be a process of registering the fact that a user has a coupon as a transaction on the blockchain, rather than distributing the coupon to the user's specific email address/phone number/residential address. According to the above configuration, a coupon distribution service provider (i.e., a servicer) can distribute coupons to users without personal information such as email addresses of the users. In another example, the smart contract SCa or the LBS server 2a may be configured to send coupon data to an email address obtainable by the DID resolving.

In the above configuration, when a user utilizes the coupon distribution service, it is sufficient for the user to transmit only the identification number as the DID and the location information to the LBS server 2a. In other words, the user does not need to provide any personal information other than the distributed identifier to the servicer. This makes it easier to protect the user's privacy. Furthermore, the DID mechanism allows users to control the information disclosed to servicers.

Furthermore, by utilizing the smart contract SCa, the LBS server 2a does not need to determine whether the location information provided by the user device 4 is located in a specific area. This makes it possible to reduce the processing load on the LBS server 2a.

In another embodiment, the LBS server 2a may be configured to register a message in the LBS-BC 62a only if the received message is authentic and the location information contained in the message satisfies specific conditions. According to this configuration, the data size of the LBS-BC 62a can be reduced.

Although the above describes an aspect in which DIDs are used to verify received data in the service server 2, the above disclosure may also be applied to user authentication processing. According to the above configuration, user authentication and data verification are performed using the DID mechanism. Therefore, specific authentication and verification methods can be standardized regardless of the nature of the service and the user device 4. A service platform using the ID management system 100 may alleviate the problems associated with implementing services that are expected to communicate with a wide variety of user devices 4.

The program product may include instructions configured to cause the computer to execute a process to display on a display a message prompting the user to obtain the storage area specified by the server when the storage area specified by the server is not available.

The present disclosure also includes an identification information management method in which the registration of the identifier and public key in the blockchain-based registry is omitted. In addition, registering the identifier and public key in the blockchain-based registry may be replaced with registering the identifier and public key in a registry that can be referenced by the service server. This disclosure also includes configurations in which the method features are applied to the server and the program product.

The various flowcharts presented in the present disclosure are merely examples, and the number of steps constituting the flowcharts or the execution order of the steps can be modified as appropriate. The controls shown in the respective flowcharts may be combined or executed in parallel to the extent that there is no contradiction. The terms obtaining, determining, detecting, generating, and calculating may be used interchangeably. When a certain device acquires certain data, the device also generates the data based on a signal input from another device/sensor. The device, the system, and the method described in the present disclosure may be implemented by a dedicated computer that is configured by a processor programmed to execute one or more functions by executing a computer program. The device and the method described in the present disclosure may be also implemented by a dedicated hardware logic circuit. The apparatus and methods described in the present disclosure may be implemented by one or more dedicated computers comprising a combination of a processor executing a computer program and one or more hardware logic circuits. The processor may be any computing core such as a CPU, an MPU, a GPU, or a DFP (Data Flow Processor). Some or all of the functions provided by the processor 11 may be implemented using a System-on-Chip (SoC), Integrated Circuit (IC), or Field-Programmable Gate Array (FPGA). A computer program comprises instructions that are executed by a computer. The computer program may be stored in a computer-readable non-transitory tangible storage medium. The computer program storage medium may be a variety of media, such as a hard-disk drive (HDD), a solid-state drive (SSD), or a flash memory.

What is claimed is:

1. An identification information management method comprising:
issuing, upon request from a device, an identifier, a private key associated with the identifier, and a public key corresponding to the private key;
acquiring data, from the device, indicative of a type of the device to identify the type of the device;
specifying a secure area in which to store the private key based on the type of the device;
storing the private key in the secure area; and
registering the identifier and the public key in a blockchain-based registry.

2. The identification information management method according to claim 1, wherein the identifier is a distributed identifier including a character string indicating a decentralized identifier method and a decentralized identifier method-specific identifier.

3. The identification information management method according to claim 1, wherein
the secure area is a storage area that is physically or logically separated from a normal area, and
the normal area is a storage area in which data is stored without being encrypted.

4. The identification information management method according to claim 1, further comprising:
presenting a message to a user of the device to prompt the user to acquire the secure area when the device does not have the secure area.

5. The identification information management method according to claim 1, further comprising:
receiving, from the device, a data set including a message, a signature value generated from the message and the private key, and the identifier;
acquiring the public key associated with the identifier from the registry based on the identifier included in the data set;
verifying an authenticity of the signature value using the public key; and
executing a process corresponding to the message when the signature value is valid.

6. A server comprising: at least one of (i) a circuit and (ii) a processor with a memory storing computer program code executable by the processor, the at least one of the circuit and the processor configured to cause the server to:
issue, upon request from a device used by a user, an identifier, a private key associated with the identifier, and a public key corresponding to the private key;
acquire data from the device indicative of a type of the device to identify the type of the device;
specify a secure area in which to store the private key based on the type of the device;
transmit a signal to the device instructing the device to store the private key in the secure area; and
register the identifier and the public key in a blockchain-based registry.

7. A computer program product stored on a non-transitory computer readable medium and comprising instructions configured to, when executed by a computer, cause the computer to
accept an issuance request of an identifier via an input device;
transmit a request signal to a server to request an issuance of the identifier based on receipt of the issuance request of the identifier;
transmit data to the server indicative of a type of the device; and
receive, from the server, a private key associated with the identifier, and store the private key in a storage area specified by the server.
